(19) United States
(12) Patent Application Publication
(10) Pub. No.: US 2008/0019260 A1
(43) Pub. Date: Jan. 24, 2008

(54) ANTI-PIRACY FOR ROM OPTICAL DISKS

(75) Inventors: Allen K. Bates, Tucson, AZ (US); Nils Haustein, Soergenloch (DE); Daniel J. Winarski, Tucson, AZ (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/459,483

(22) Filed: Jul. 24, 2006

(51) Int. Cl. G11B 7/24

(52) U.S. Cl. 369/275.4

(57) ABSTRACT

A Blu-ray Disc™ optical disk for video and/or audio applications comprises a data layer having in-pits recessed into a surface of at least one data layer and on-pits elevated above the surface of at least one data layer, and further having a substrate layer disposed on each data layer. The in-pits and the on-pits may be disposed in the same data layer or on different data layers. The in-pits and the on-pits are indistinguishable from each other when read using an optical drive, and the in-pits and the on-pits are observable by SEM cross-section of the data layer of the Blu-ray Disc™ optical disk. A method for anti-piracy tagging a Blu-ray Disc™ optical disk by patterning a data layer to have in-pits and on-pits is also provided, wherein the in-pits and the on-pits are indistinguishable from each other when read using an optical drive, and are observable by SEM.

### TRADEMARKS

Blu-ray Disc™ is a registered trademark of Sony Kabusliiki Kaisha Corporation Japan 7-35, Kitashinagawa 6-chome Shinagawa-ku, Tokyo, Japan.

### BACKGROUND OF THE INVENTION

1. Field of the Invention

The problem solved by our invention is one of countering the piracy of video and audio streams from Read-Only-Memory (“ROM”) optical disks. Specifically, the invention relates to an anti-piracy tagging of the Blu-ray Disc™ ROM optical disk.

2. Description of Background

Blu-ray Disc™ is an emerging data storage technology for advanced multi-layer optical disks. A Blu-ray Disc™ optical disk can have a data storage capacity of about 15 to 50 gigabytes (GB) per readable layer, and can accommodate up to 8 layers of data for a data storage capacity of up to about 400 GB. The technology reads physical features etched into the read layer of a Blu-ray Disc™ optical disk that are smaller than the features used in either CD or DVD technologies. Blu-ray Disc™ technology uses a 405±5 nm blue laser light to read up to eight layers of data on the read side (i.e., the side to be read) of a Blu-ray Disc™ optical disk. Blu-ray Disc™ optical disks are primarily to be used for video, audio, or both. Because the Blu-ray Disc™ ROM optical disk can hold so much information, it is a likely target for piracy.

### SUMMARY OF THE INVENTION

The shortcomings of the prior art are overcome and additional advantages are provided through the provision of countering piracy of video and audio streams from ROM optical disks by providing, in an embodiment, an optical disk for video and/or audio applications comprising a data layer having in-pits recessed into a surface of at least one data layer and on-pits elevated above the surface of at least one data layer, wherein the in-pits and the on-pits are indistinguishable from each other when read using an optical drive. In a specific embodiment, the optical disk is a Blu-ray Disc™ optical disk.

In a further embodiment, the in-pits and the on-pits are disposed on the same data layer or on different data layers, and the in-pits and on-pits alternate in the data layer along a circular or spiral track of the optical disk or the in-pits and on-pits are each disposed in a different region of the data layer. The in-pits are recessed into the surface of the data layer by a depth d, the on-pits are elevated above the surface of the data layer by an elevation d, and the depth d of the in-pits and the height d of the on-pits are the same for each data layer and are determined according to the equation:

d=nλ/4

wherein λ is 405±5 nanometers, and n is the refractive index of a substrate layer disposed on each data layer. The in-pits and the on-pits are observable by SEM cross-section of the data layer of the optical disk.

In another embodiment, a method for anti-piracy tagging an optical disk comprises patterning a data layer of the optical disk to have in-pits recessed into a surface of the data layer and on-pits elevated above the surface of the data layer, wherein the in-pits and the on-pits are indistinguishable when read using an optical drive, and are observable by scanning electron microscopy of a cross-section of the data layer of the optical disk.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides for anti-piracy tagging of an optical disk such as a Blu-ray Disc™ optical disk by using a combination of both in-pit and on-pit readable regions that cannot be distinguished by reading the pits using a blue light laser operating at 405±5 nm, but can be observed according to the height difference by using a suitable method of distinguishing the physical profile of the pits, such as by using fast ion bombardment (FIB) or cryogenic cross-sectioning and scanning electron microscopy (SEM), where the height or depth of a pit is about one quarter of the wavelength of the light source used in reading the disks (e.g., 405±5 nm). By providing a Blu-ray Disc™ optical disk or other high data content optical disk such as, for example, a high-definition digital video disk (HD-DVD) having both in-pits and on-pits in the readable region of the disk, the combination of in-pits and on-pits can be used as a tag to prevent illegal copying (i.e., piracy) of the data content of these optical disks. The use of a combination of in-pits and on-pits in the readable regions of the disk can help protect this new optical format from piracy.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example of a cross-section of an anti-piracy ROM optical disk.

The detailed description explains the preferred embodiments of the invention, together with advantages and features, by way of example with reference to the drawings.

### DETAILED DESCRIPTION OF THE INVENTION

The deficiencies of the prior art may be overcome by an optical disk such as, for example, a Blu-ray Disk ™ ROM (Read Only Memory) optical disk or other high data content optical disk having both in-pit (concave) and on-pit (convex) pits which constitute the readable features in the data layer of the optical disk. An optical drive which uses a blue light laser operating at a wavelength of 400 to 410 nanometers (i.e., 405±5 nm) and reads using a lens with a high numerical aperture (NA) of 0.85, is unable to distinguish between these two kinds of pits. The pits can be observed and differentiated using a technique such as scanning electron microscopy (SEM) of a cross-section of the data layer of the Blu-Ray disk. The presence of both the in-pits and on-pits in the data layer can be used to differentiate between an original Blu-ray Disc™ optical disk and a pirated optical disk using the Blu-ray Disc™ format. Hence, in this way the presence of these two pits can be used for anti-piracy tagging of the Blu-ray Disc™ ROM optical disks.

The Blu-ray Disc™ optical disk typically is constructed of a substrate having one or more data layers (up to 8 data layers in total), in which the data layers are separated by a transparent spacer layer prepared from the same material or a different material used to prepare the substrate. The substrate has a nominal thickness of about 1.1 millimeters (mm). The substrate also has a transparent cover layer with a thickness of about 0.1 mm over the readable surface of the optical disk. Where multiple data layers are used, thinner layers of the transparent cover layer are disposed between the data layers and over the data layers, and a total thickness for the transparent cover layer of 0.1 mm is maintained. The total nominal thickness for the optical disk is 1.2 mm, which is comparable to the thickness of a digital video disk (DVD). The pits (both in-pits and on-pits) are typically 60 to 120 nm in length depending on what kind of binary data is encoded by the pit, wherein the length of the pit generally determines the number of zeroes “0” encoded by the pit, and the ends of the pits are read as ones “1”.

Typical substrate materials used in the construction of the substrate include thermoformable, injection moldable plastics such as, for example, polycarbonates, polyesters, polyacrylates, polystyrenes, and the like. An exemplary substrate material useful for forming a substrate is a polycarbonate.

The in-pits are recessed into the surface of the data layer by a depth sufficient to distinguish the in-pit from the surface. Similarly, the on-pits are elevated above the surface of the data layer by an elevation sufficient to differentiate the on-pit from the surface. In an embodiment, the depth of the in-pits and the height of the on-pits are the same, such that the in-pits are recessed into the surface of the data layer by the same amount as the on-pits are raised above the surface of the data layer. This distance d corresponding to the depth of the in-pit and/or the height of the on-pit is determined using the equation:

d=nλ/4

wherein λ is the wavelength (in nanometers) of the laser of the optical drive used to read the optical disk, and n is the refractive index of the substrate layer.

The in-pits and the on-pits may be disposed in the data layer of the optical disk in any of a number of different configurations. For example, the in-pits and the on-pits may be disposed in the same data layer, and may be present along a circular or spiral track of the optical disk wherein the in-pits and the on-pits alternate with each other. Alternatively, the in-pits and the on-pits may be present in different regions of the same data layer. For example, alternate circular or spiral tracks may be in-pits alternating with on-pits. In another example, sectors of a track may have one kind of pit (such as an in-pit), while other sectors may have the other kind of pit (e.g., an on-pit). In another embodiment, where the optical disk comprises more than one data layer, in-pits and on-pits may be disposed in different layers, or in the same layer using a configuration as described above. It will be understood that all configurations of the in-pits and on-pits in a optical disk as described herein are contemplated provided that both in-pits and on-pits are present in the data layer, and that the foregoing examples are meant to be exemplary and should not be considered as limiting thereto.

The data layer of a Blu-ray Disc™ optical disk is patterned using a mastering process, in which the pattern can be transferred from the master to the disk using any of a variety of techniques including molding, templating, pressing, or a combination of these techniques. The master disk is itself patterned to have concentric circular or spiral patterns of pits (in-pits, on-pits, or a combination) corresponding to the data regions in the optical disk, using mastering methods including Phase Transition Metal (PTM) mastering, in which an inorganic photosensitive compound is patterned using a laser to create a phase change in the exposed areas, which are then dissolved away using a developer thereby creating a feature on the master; Electron-Beam mastering, in which an electron beam is used to expose (i.e., write) a pattern on a photoresist layer on the surface of the master and thereby write the pits on the surface of the master; and Deep-UV Liquid Immersion mastering, in which a pattern is transferred to a photoresist layer on the surface of the master using an immersion lens in which the objective exposure lens tracks across the photoresist surface to be exposed while a layer of a liquid (such as for example degassed, high purity water) is injected between and in contact with both the lens and the surface of the photoresist. Of these mastering methods, the Deep-UV Liquid Immersion mastering method, developed to increase the effective numerical aperture of the objective lens and thereby increase the writing resolution of the lens to provide sufficiently small readable features (i.e., pits) for the reading wavelength of 405±5 nm, is best suited to provide both in-pit and on-pit features on a master surface.

In an exemplary embodiment, the in-pits and on-pits of the data layer are imaged and created on a master disk using Deep UV Liquid Immersion mastering, and the in-pits and on-pits are then transferred to the data layer of the optical disk by injection molding the substrate material onto the surface of the master having the in-pits and on-pits, and releasing the injection molded disk from the master. Subsequent processing steps, including sputter-coat or vapor metallization (e.g., aluminization) of a reflective layer on the disk, application of a transparent coating layer to the data layer, and patterning and transparent coating of additional data layers, can also be performed as needed. The optical disk so prepared has both in-pits and on-pits in at least one data layer.

Determining the presence of the in-pits and on-pits in the optical disk may be accomplished by using a suitable microscopy method such as scanning electron microscopy (SEM), transmission electron microscopy (TEM), or the like, wherein such imaging methods are useful for distinguishing between compositionally different or delineated regions which can have different densities or compositions, or which may be separated by thin layers of a different material such as, for example, a sputtered or deposited metal or ceramic material (e.g., aluminum, gold, tungsten, chromium, titanium nitride, silicon nitride, and the like). Such regions may be completely or partially reflective of incident light

Exposing the regions to be imaged can be accomplished using standard cross sectioning (i.e., by cutting, cleaving, or cryogenic fracture by freezing using liquid nitrogen or liquid helium followed by cleaving) or by ion sputtering using fast ion bombardment to erode into the surface of the optical disk to be tested (i.e., a Blu-ray Disc™ optical disk or an optical disk suspected of being a pirated copy). Fast ion bombardment (FIB), in which a stream of ions such as gallium ions is directed at the surface and erodes into the surface of the optical disk, is a useful method to expose the in-pits and on-pits in an observable cross-section.

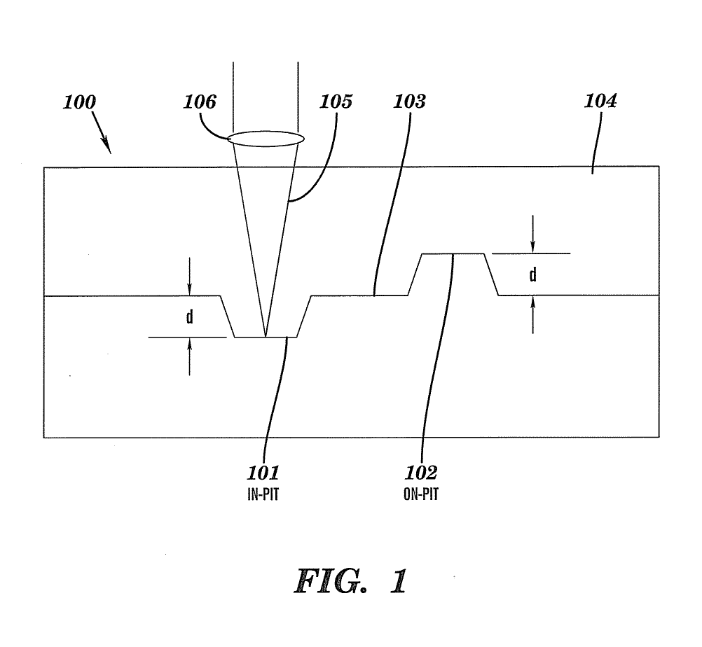

In an exemplary embodiment, FIG. 1 shows a Blu-ray Disc™ ROM optical disk 100. In-pit 101 and on-pit 102 are shown in data layer 103, where the depth of the in-pit 101 and the height of the on-pit 102 are shown by d. The preferred mastering process for a Blu-ray Disc™ ROM optical disk uses a liquid immersion lens (not shown) which permits creation of both in-pits 101 and on-pits 102 in the same data layer 103.

To the optical drive, in-pits 101 and on-pits 102 are indistinguishable and are both read as “dark”, i.e., each provides a signal to the optical drive, because the pits are of a depth or height d, where d equals the refractive index n of substrate material 104 times the wavelength λ of the laser light 105 (405±5 nm) divided by four. To read the Blu-ray Disc™ optical disk, laser light 105 is focused onto data layer 103 by focus lens 106, which resides in the optical drive. While in FIG. 1 the laser light 105 is shown reading in-pit 101, it will be understood that laser light 105 is also used to read on-pit 102. Thus, an optical drive used to read the Blu-ray Disc™ optical disk 100 for purposes of piracy will read in-pits 101 and on-pits 102 identically, that is to say in-pits 101 and on-pits 102 will each be read equally by the optical drive as though all pits were either in-pits or on-pits and will not be differentiated between by the optical drive. However, a FIB or other cross-section of the data layer 103 viewed by SEM will reveal the presence of both readable in-pits 101 and on-pits 102 of the original (i.e., non-pirated) copy of Blu-ray Disc™ optical disk 100, whereas a pirated copy (not shown) of Blu-ray Disc™ optical disk 100 will have only in-pits, on-pits, or a pattern of in-pits and on-pits not matching the original. In this way, cross-section and SEM of a Blu-ray Disc™ optical disk can be used to distinguish an originally mastered disk from a pirated copy.

To assist in determining the presence of in-pits and on-pits, certain regions of the disk may be entirely on-pits 102 or may alternate read in-pits 101 and on-pits 102 for ease of identification.

A method of providing an anti-piracy optical disk is also contemplated. In the method, a data layer of an optical disk is patterned using one or more of the above mastering techniques to have in-pits recessed into a surface of the data layer and on-pits elevated above the surface of the data layer. The in-pits and the on-pits so provided are indistinguishable when read using an optical drive, and are observable by scanning electron microscopy of a cross-section of the data layer of the optical disk. It will be understood that the method described herein can be applied to other optical disks, such as those having a high data content. In an embodiment, the method is applicable to optical disks which can be read using a blue light laser having an operating wavelength of 405±5 nm. In a specific embodiment, the optical disk is a Blu-ray Disc™ optical disk.

The capabilities of the present invention can be implemented in software, firmware, hardware or some combination thereof.

As one example, one or more aspects of the present invention can be included in an article of manufacture (e.g., one or more computer program products) having, for instance, computer usable media, media usable by video equipment, media usable by audio equipment, and the like, or a combination of these. The media has embodied therein, for instance, computer, video, or audio equipment readable program code means for providing and facilitating the capabilities of the present invention. The article of manufacture can be included as a part of a computer system or sold separately.

Additionally, at least one data storage device readable by a machine, tangibly embodying at least one program of instructions executable by the machine to perform the capabilities of the present invention can be provided.

It will be understood that there may be many variations to the above-described articles and methods that can include features or steps (or operations) described therein without departing from the spirit of the invention. For instance, the features or steps may be performed in a differing order, or the features or steps may be added, deleted or modified. All of these variations are considered a part of the claimed invention.

The singular forms “a,” “an,” and “the” include plural referents unless the context clearly dictates otherwise. The endpoints of all ranges reciting the same characteristic or component are independently combinable and inclusive of the recited endpoint. All references are incorporated herein by reference. The terms “first,” “second,” and the like herein do not denote any order, quantity, or importance, but rather are used to distinguish one element from another. As used herein and unless otherwise specified, the terms “disposed on” and “disposed in” mean “in at least partial contact with”.

While the preferred embodiment to the invention has been described, it will be understood that those skilled in the art, both now and in the future, may male various improvements and enhancements which fall within the scope of the claims which follow. For example, the embodiment may apply to any optical disk with in-pits and on-pits. These claims should be construed to maintain the proper protection for the invention first described.

What is claimed is:

1. An optical disk comprising a data layer having in-pits recessed into a surface of the data layer and on-pits elevated above the surface of the data layer, wherein the in-pits and the on-pits are indistinguishable from each other when read using an optical drive.

2. The optical disk of claim 1, wherein the in-pits and the on-pits alternate in the data layer along a circular or spiral track of the optical disk.

3. The optical disk of claim 1, wherein the in-pits and the on-pits are each disposed in a different region of the data layer.

4. The optical disk of claim 1 further comprising a substrate layer disposed on the surface of the data layer having the in-pits and the on-pits.

5. The optical disk of claim 4, wherein the in-pits are recessed into the surface of the data layer by a depth d, the on-pits are elevated above the surface of the data layer by an elevation d, and the depth d of the in-pits and the height d of the on-pits are the same.

6. The optical disk of claim 5, wherein d is determined according to the equation:
d=nλ/4
wherein λ is the wavelength in nanometers of a laser used to read the optical disk, and n is the refractive index of the substrate layer.

7. The optical disk of claim 2, wherein the wavelength λ is from 400 to 410 nm.

8. The optical disk of claim 4, wherein the optical disk comprises an additional data layer disposed on the surface of the substrate opposite the data layer, wherein the additional data layer comprises in-pits, on-pits, or a combination of in-pits and on-pits.

9. The optical disk of claim 8, wherein the in-pits and on-pits are disposed on the same data layer or on different data layers.

10. The optical disk of claim 1 wherein the optical disk comprises 1 to 8 data layers.

11. The optical disk of claim 1, wherein the optical disk is used for recording video, audio, software, data, or a combination comprising at least one of the foregoing.

12. The optical disk of claim 1, wherein the in-pits and the on-pits are observable by scanning electron microscopy of a cross-section of the data layer of the optical disk.

13. The optical disk of claim 12, wherein the optical disk is cross-sectioned using fast ion bombardment.

14. The optical disk of claim 12, wherein the optical disk is cross-sectioned using cryogenic fracture.

15. The optical disk of claim 1, wherein the optical disk is a Blu-ray Disc™ Read-Only Memory optical disk.

16. A Blu-ray Disc™ optical disk for video, audio, or both video and audio applications, comprising 1 to 8 data layers having in-pits recessed into a surface of at least one data layer and on-pits elevated above the surface of at least one data layer, and further having a substrate layer disposed on each data layer;
wherein the in-pits and the on-pits are disposed on the same data layer or on different data layers, and the in-pits and on-pits alternate in the data layer along a circular or spiral track of the optical disk or the in-pits and on-pits are each disposed in a different region of the data layer;
wherein the in-pits are recessed into the surface of the data layer by a depth d, the on-pits are elevated above the surface of the data layer by an elevation d, and the depth d of the in-pits and the height d of the on-pits are the same for each data layer and are determined according to the equation:
d=nλ/4
wherein λ is from 400 to 410 nanometers, and n is the refractive index of the substrate layer disposed on each data layer;
wherein the in-pits and the on-pits are indistinguishable from each other when read using an optical drive, and the in-pits and the on-pits are observable by scanning electron microscopy of a fast ion bombardment cross-section of the data layer of the optical disk.

17. A method for anti-piracy tagging an optical disk comprising
patterning a data layer of the optical disk to have in-pits recessed into a surface of the data layer and on-pits elevated above the surface of the data layer,
wherein the in-pits and the on-pits are indistinguishable from each other when read using an optical drive, and
wherein the in-pits and the on-pits are observable by scanning electron microscopy of a cross-section of the data layer of the optical disk.

18. The method of claim 17, wherein the optical disk is a Blu-ray Disc™ Read-Only Memory optical disk.
